(19) United States
(12) Patent Application Publication
(10) Pub. No.: US 2014/0006276 A1
(43) Pub. Date: Jan. 2, 2014

(54) MOBILE WALLET ACCOUNT NUMBER DIFFERENTIATION

(71) Applicants: David M. Grigg, Rock Hill, SC (US); Alicia C. Jones, Fort Mill, SC (US); Laura Corinne Bondesen, Charlotte, NC (US); Peter John Bertanzetti, Charlotte, NC (US); Steven M. Twombly, Saco, ME (US)

(72) Inventors: David M. Grigg, Rock Hill, SC (US); Alicia C. Jones, Fort Mill, SC (US); Laura Corinne Bondesen, Charlotte, NC (US); Peter John Bertanzetti, Charlotte, NC (US); Steven M. Twombly, Saco, ME (US)

(73) Assignee: Bank of America Corporation, Charlotte, NC (US)

(21) Appl. No.: 13/536,866

(22) Filed: Jun. 28, 2012

(51) Int. Cl. G06Q 20/36

(52) U.S. Cl. 705/41

(57) ABSTRACT

Embodiments of the invention include systems, methods, and computer-program products for providing a mobile wallet account number associated with all of the payment devices on a mobile wallet. In this way, if the mobile wallet it misplaced, the user may not have to cancel and re-open each of the payment devices on the mobile wallet. The cancelling and re-opening process may be time consuming and effect other automatic transactions associated with the payment devices. The system provides a mobile wallet account number to a merchant and the merchant may process the transaction using that account number. Subsequently, the system may associate the mobile wallet account number with a payment device and apply the transaction to that payment device.

### BACKGROUND

Typically, individuals may shop on-line or at a merchant's place of business in order to purchase products he/she may want. When an individual finds the products that he/she wishes to purchase, the individual may purchase the product by tendering a payment device to the merchant. A payment device may typically include cash, credit cards, debit cards, gift cards, checks, or the like.

Recently, individuals have been giving the option of using a mobile wallet or e-wallet as a payment device. Mobile wallets store many of the individual's payment devices, such as credit cards, on a mobile device. The individual may present the mobile device as an alternative to the payment devices.

However, a mobile wallet is typically associated with the individual's mobile device, such as his/her mobile phone. Mobile phones are misplaced, lost, stolen, and the like. As such, the financial data associated with the individual's mobile wallet may also be lost and/or stolen. Since the mobile wallet may store most of the individual's payment devices, a lost or stolen mobile phone may require an individual to call each payment device supplier and cancel those accounts.

Therefore, a need exists for a way to provide security to the financial accounts associated with a mobile wallet such that if an individual's mobile phone is lost or stolen, the individual's financial information is secure.

### BRIEF SUMMARY

Embodiments of the present invention address the above needs and/or achieve other advantages by providing apparatuses (e.g., a system, computer program product and/or other devices) and methods for assigning an alternative mobile wallet account number for the payment devices associated with a mobile wallet, such that the mobile wallet may use that alternative mobile wallet account number for a transaction. This way, the account numbers associated with the payment accounts are not accessible via a user's mobile device.

Embodiments of the present invention provide a mobile wallet account number for use during a mobile wallet transaction to complete the transaction, such that a mobile wallet transaction may not have to use a payment device account number (such as a traditional bank account number) for the transaction. In some embodiments, there may be a different mobile wallet account number for each of the payment devices associated with the mobile wallet. As such, if a mobile wallet is misplaced, the user may cancel the mobile wallet account number without affecting any payment device account itself.

Traditionally, a mobile wallet may have included account numbers, names, expiration dates, or the like that were associated with the payment devices added. For example a user may input Credit Card 1 onto his/her mobile wallet. The information stored in the mobile wallet may have included only the information necessary to make a payment using Credit Card 1. As such, the account number, expiration date, security code, name, and the like may have been stored within the mobile wallet. However, if a mobile wallet of a user is misplaced, the user may have to go through great lengths to cancel the account numbers associated with each payment device associated with the mobile wallet. As such, this cancellation may affect any automatic transaction or the like associated with the payment device.

In some embodiments, the system may determine that a user is using a mobile wallet for transactions. A mobile wallet may be any type of digital wallet that may be an alternative payment method using a mobile device to pay for a product. Mobile wallets allow a user to make electronic commerce transactions via his/her mobile device quickly and securely. In some embodiments, the user may manually input the payment devices into his/her mobile wallet. In other embodiments, the payment devices may be automatically inputted into his/her mobile wallet.

In some embodiments, once the system determines that a user may be using a mobile wallet for transactions, the system may determine the payment devices the user has associated with his/her mobile wallet. In some embodiments, the user may have one payment device associated with a mobile wallet, such as a credit card or debit card. In other embodiments, the user may have multiple payment devices associated with a mobile wallet. As, the system may determine the one or more payment devices that a user has associated with his/her mobile wallet. This may be done by accessing the user's mobile wallet, reviewing mobile wallet transactions, monitoring payment devices added to the mobile wallet, and/or the like.

In some embodiments, upon determining the payment devices associated with the mobile wallet, the system may determine the account numbers associated with that payment devices. In some embodiments, the payment devices may comprise one or more account numbers that are used to access the accounts associated with the payment devices. In these cases, the system may determine the account numbers associated with the payment devices of the user's mobile wallet.

The system may then assign a mobile wallet account number for the user's mobile wallet and/or each of the payment devices associated therewith. In some embodiments, the mobile wallet account number may be permanently associated with the mobile wallet. In some embodiments, the mobile wallet account number may be temporarily associated with the mobile wallet. In some embodiments, the mobile wallet account number may be a one-time use account number for the mobile wallet. In some embodiments, there may be a different mobile wallet account number for each payment device associated with the mobile wallet. In some embodiments, there may be one mobile wallet account number for all of the payment devices associated with the mobile wallet. The mobile wallet account number is a distinct number that is different from any traditional financial institution account number or any other account number associated with a payment device. However, the mobile wallet account number may be utilized for a transaction for a product.

In this way, the one or more mobile wallet account number may be presented by a mobile wallet and be used as a traditional payment device account number to purchase a product during a transaction. In this way, a merchant may accept the mobile wallet account number as satisfying the payment for a transaction.

Once a merchant accepts the mobile wallet payment, the merchant may attempt to reconcile the payment. As such, in some embodiments, the system may provide the merchant with the appropriate payment device and account number associated therewith in replace of the mobile wallet account number the merchant received. In this way, the merchant may be able to process the transaction and apply the payment amount to the appropriate payment device associated with the mobile wallet account number.

In this way, a mobile wallet utilizing the mobile wallet account number differentiation system may not have stored and/or have access to the actual financial accounts associated with payment devices on the mobile wallet. In this way, if the mobile wallet is misplaced, lost, or the like the financial accounts associated with the payment devices on the mobile wallet are not also misplaced. As such, a user may not need to cancel each and every payment device individually, which as discussed above would likely happen if a traditional mobile wallet was misplaced. Instead, utilizing the mobile wallet account number differentiation system a user may cancel the mobile wallet account number. The system may then cancel all transactions associated with that mobile wallet account number. The system may also in real-time or close thereto, issue a new mobile wallet account number to the user. As such, the cancellation of the mobile wallet account number does not affect the actual accounts associated with the payment devices, as such any automatic transaction or the like associated with the payment device will still be functioning.

Embodiments of the invention relate to systems, methods, and computer program products for providing a mobile wallet account number, the invention comprising: receiving an indication that a user has activated a mobile wallet, wherein the mobile wallet comprises one or more payment devices; receiving data associated with each of the one or more payment devices associated with the mobile wallet, wherein the data includes the payment devices account number; creating a mobile wallet account number for the one or more payment devices; storing the mobile wallet account number in association with the payment device account numbers for each of the one or more payment devices; receiving an indication that the user is entering into a transaction using the mobile wallet, wherein the transaction comprises presenting the mobile wallet and mobile wallet account number to a merchant; determining the one or more payment devices associated with the mobile wallet account number; and applying the transaction to an appropriate payment device account.

In some embodiments, the invention further comprises: determining the appropriate payment device account associated with the one or more payment devices associated with the mobile wallet account number, wherein determining the appropriate payment device account associated with the one or more payment devices comprises at least one of: determining a payment device from the one or more payment devices the user has used in previous transactions with the merchant; determining a payment device from the one or more payment devices that provides the user with incentives when transaction with the merchant; or receiving a manual input from the user indication the appropriate payment device; and apply the transaction to the determined appropriate payment device account.

In some embodiments, creating the mobile wallet account number for all of the one or more payment devices further comprises allowing the user to remove the payment device account numbers from the mobile wallet and replace the payment device account numbers with the single mobile wallet account number.

In some embodiments, applying the transaction to an appropriate payment device account further comprises: matching the mobile wallet account number with the payment device account numbers associated with the mobile wallet; determining the appropriate payment device account from the payment device account numbers associated with the mobile wallet account number; accessing the appropriate payment device account number; and allowing for transaction processing of the appropriate payment device account number.

In some embodiments, the mobile wallet account number is an acceptable form of payment for a transaction at a merchant, wherein the mobile wallet account number is not directly associated with a payment device account number. In some embodiments, the mobile wallet account number is associated with the mobile wallet until the user cancels the mobile wallet account number. In yet other embodiments, the mobile wallet account number is a one-time use account number, such that after each transaction the mobile wallet account number changes.

In some embodiments, the invention further comprises: receiving an indication of a misplaced mobile wallet; receiving a request to cancel and re-issue a mobile wallet account number; and providing the user with a new mobile wallet account number based on the request, wherein the one or more payment devices associated with the misplaced mobile wallet remain unaffected by the misplacement of the mobile wallet, such that the payment device account numbers associated with the one or more payment devices do not require cancelling.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 provides a high level process flow illustrating a mobile wallet account number differentiation method, in accordance with one embodiment of the present invention;

FIG. 2 provides a mobile wallet account number differentiation system environment, in accordance with one embodiment of the present invention;

FIG. 3 provides a process map illustrating the process of initiating a mobile wallet account number differentiation system with a mobile device, in accordance with one embodiment of the present invention;

FIG. 4 provides a process map illustrating the process of using a mobile wallet with the mobile wallet account number differentiation system, in accordance with one embodiment of the present invention;

FIG. 5 provides a process map illustrating the process of a user using a mobile wallet with the mobile wallet account number differentiation system, in accordance with one embodiment of the present invention; and

FIG. 6 provides a process map illustrating the a comparison of the steps a user may take when a mobile wallet is misplaced, in accordance with one embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. A “payment device” as used herein may refer to any means of payment for a product of a transaction. As such a payment device may include, but is not limited to a credit card, debit card, currency, paper money, coin money, lines of credit, gift cards, checks, virtual currency, electronic payment means, or the like A “merchant” as used herein may refer to a manufacturer, retailer, service provider, event provider, warehouse, supplier, and/or the like. Furthermore, as used herein, the term “product” shall mean any good, service, event, or the like that may be offered by a merchant.

Further, the embodiments described herein may refer to use of a transaction or transaction event at a point-of-transaction (POT) using a mobile wallet. Unless specifically limited by the context, a “transaction” refers to any communication between the user and a merchant, financial institution, or other entity. For example, in some embodiments, a transaction may include one or more of the following: purchasing, renting, leasing, bartering, selling, and/or leasing goods and/or services (e.g., groceries, stamps, tickets, DVDs, vending machine items, or the like); withdrawing cash; making payments to creditors (e.g., paying monthly bills; paying federal, state, and/or local taxes and/or bills; or the like); sending remittances; transferring balances from one account to another account; loading money onto stored value cards (SVCs) and/or prepaid cards; donating to charities; and/or the like. For example, a transaction may occur when a user purchases a product at a merchant. In yet other embodiments, for example, a transaction may occur when an entity associated with the user is alerted. A transaction may occur when a user accesses a building, uses a rewards card, and/or performs an account balance query. A transaction may occur as a user's device establishes a wireless connection, such as a Wi-Fi connection, with a point-of-transaction terminal.

In still further embodiments, a transaction may refer to an event and/or action or group of actions facilitated or performed by a user's device, such as a user's mobile system, a merchant system, and/or a combination thereof. A device capable of facilitating or performing a transaction may be referred to herein as a “POT system” or “POT device.” A “point-of-transaction” or “POT” could refer to any location, virtual location or otherwise proximate occurrence of a transaction. A POT system may refer to any device used to perform a transaction, either from the user's perspective, the merchant's perspective or both. In some embodiments, the POT system refers only to a user's system, in other embodiments it refers only to a merchant system, and in yet other embodiments, it refers to both a user device and a merchant device interacting to perform a transaction. For example, in one embodiment, the POT system refers to the user's mobile device configured to communicate with a merchant's system, whereas in other embodiments, the POT system refers to a merchant's system configured to communicate with a user's mobile device, and in yet other embodiments, the POT system refers to both the user's mobile device and the merchant's system configured to communicate with each other to carry out a transaction.

In some embodiments, a POT system is or includes an interactive computer terminal that is configured to initiate, perform, complete, and/or facilitate one or more transactions. A POT system could be or include any device that a user may use to perform a transaction with an entity, such as, but not limited to, an ATM, a loyalty device such as a rewards card, loyalty card or other loyalty device, a magnetic-based payment device (e.g., a credit card, debit card, or the like), a personal identification number (PIN) payment device, a contactless payment device (e.g., a key fob), a radio frequency identification device (RFID) and the like, a computer, (e.g., a personal computer, tablet computer, desktop computer, server, laptop, or the like), a mobile device (e.g., a smartphone, cellular phone, personal digital assistant (PDA) device, MP3 device, personal GPS device, or the like), a merchant terminal, a self-service machine (e.g., vending machine, self-checkout machine, or the like), a public and/or business kiosk (e.g., an Internet kiosk, ticketing kiosk, bill pay kiosk, or the like), a gaming device, and/or various combinations of the foregoing.

In some embodiments, a POT system is operated in a public place (e.g., on a street corner, at the doorstep of a private residence, in an open market, at a public rest stop, or the like). In other embodiments, the POT system, is additionally or alternatively operated in a place of business (e.g., in a retail store, post office, banking center, grocery store, factory floor, or the like). In accordance with some embodiments, the POT system is not owned by the user of the POT system. Rather, in some embodiments, the POT system is owned by a mobile business operator or a POT operator (e.g., merchant, vendor, salesperson, or the like). In yet other embodiments, the POT system is owned by the financial institution offering the POT system providing functionality in accordance with embodiments of the invention described herein.

Some portions of this disclosure are written in terms of a financial institution's unique position with respect to payment device suppliers, such as merchants, credit companies, other financial institutions, or the like As such, a financial institution may be able to utilize its unique position to provide a user with a mobile wallet account number. A financial institution may also be able to utilize its unique position to provide access and/or provide payment device account numbers to merchants based on mobile wallet account numbers.

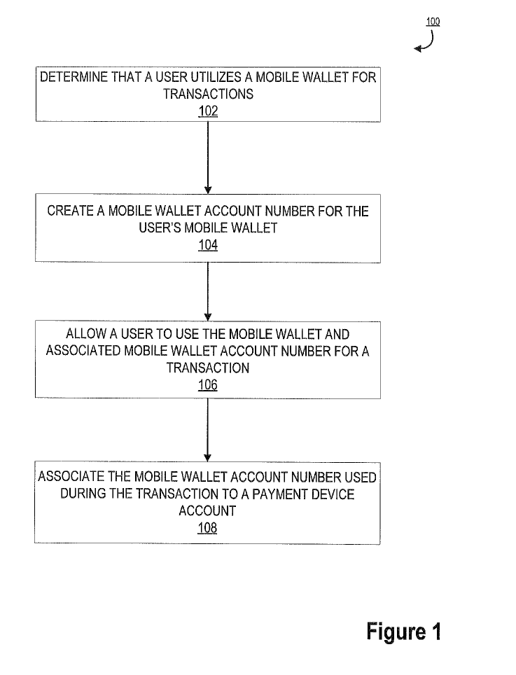

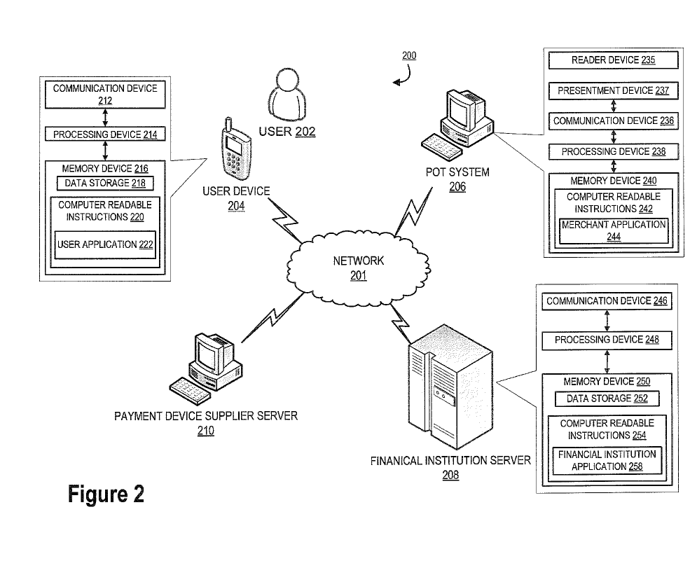

FIG. 1 provides a high level process flow illustrating a mobile wallet account number differentiation method 100, in accordance with one embodiment of the present invention, which will be discussed in further detail throughout this specification with respect to FIGS. 2 through 6. The first step in the process 100, as illustrated in block 102 is to determine that a user utilizes a mobile wallet for transactions. The system may determine this in many ways, including but not limited to user notification, merchant notification, mobile wallet system notification, financial institution notification, user device notification, and/or the like.

Once the system determines that a user is using a mobile wallet for transacting with merchants, the system may receive an indication that the user is interesting in using the mobile wallet account number differentiation program. In some embodiments, the user may manually enroll in the program. In some embodiments, the user may be automatically enrolled in the program. In yet other embodiments, the provider of the mobile wallet, such as a financial institution, may require a user enroll in the program prior to using the mobile wallet.

In some embodiments, as illustrated in block 104, the system may create a mobile wallet account number for the user's mobile wallet. In some embodiments, the mobile wallet account number may be permanently associated with the mobile wallet. In some embodiments, the mobile wallet account number may be temporarily associated with the mobile wallet. In some embodiments, the mobile wallet account number may be a one-time use account number for the mobile wallet. The mobile wallet account number is a distinct number that is different from any traditional financial institution account number or any other account number associated with a payment device. However, the mobile wallet account number may be utilized for a transaction for a product. The mobile wallet account number may be numbers, letters, symbols, or the like that may be recognized at a point-of-transaction (POT) as an account number, such that the mobile wallet account number may be used for purchasing a product.

Once the mobile wallet account number has been created, the user is allowed to use the mobile wallet and the mobile wallet account number associated therewith for a transaction, as illustrated in block 106. As such, the user may present his/her mobile wallet at a POT for a transaction. The merchant at the POT may recognize the user's mobile wallet for payment for the products of the transaction. The POT may then process the transaction using the mobile wallet account number. As such, the transaction may be accepted or denied based on that mobile wallet account number.

Upon using the mobile wallet to complete a transaction the merchant may attempt to process the transaction. As such, the system once a transaction has been initiated using the mobile wallet account number may provide the merchant with the actual account associated with the payment device the user wished to utilize with his/her mobile wallet. As such, as illustrated in block 108, the system may associate the mobile wallet account number to a payment device account number.

FIG. 2 provides a mobile wallet account number differentiation system environment 200, in accordance with one embodiment of the present invention. As illustrated in FIG. 2, the financial institution server 208 is operatively coupled, via a network 201 to the user device 204, the POT system 206, and the payment device supplier server 210. In this way, the financial institution server 208 can send information to and receive information from the user device 204, POT system 206, and the payment device supplier server 210 to allow a user to use a mobile wallet account number for a transaction using a mobile wallet, such that the user may not have to store accounts directly associated with a payment device on his/her mobile wallet.

FIG. 2 illustrates only one example of an embodiment of a mobile wallet account number differentiation system environment 200, and it will be appreciated that in other embodiments one or more of the systems, devices, or servers may be combined into a single system, device, or server, or be made up of multiple systems, devices, or servers.

The network 201 may be a global area network (GAN), such as the Internet, a wide area network (WAN), a local area network (LAN), or any other type of network or combination of networks. The network 201 may provide for wireline, wireless, or a combination wireline and wireless communication between devices on the network.

In some embodiments, the user 202 is an individual making a transaction, such as a financial transaction. The transaction may be made at a point-of-transaction (POT) of a merchant, online or offline, at the merchant's place of business and/or other transaction means. The purchase may be made by the user 202 using any type of payment device available to the user 202, such as, but not limited to cash, credit cards, debit cards, gift cards, checks, lines-of-credit, or the like Furthermore, the user 202 may use his/her user device 204 as a mobile wallet or other types of payment system that may communicate with a POT to allow the user 202 to complete a transaction. Furthermore, in some embodiments, the user 202 may be a merchant or a person, employee, agent, independent contractor, or the like acting on behalf of the merchant to enter into a transaction.

As illustrated in FIG. 2, the financial institution server 208 generally comprises a communication device 246, a processing device 248, and a memory device 250. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 248 is operatively coupled to the communication device 246 and the memory device 250. The processing device 248 uses the communication device 246 to communicate with the network 201 and other devices on the network 201, such as, but not limited to the POT system 206, the payment device supplier server 210, and the user device 204. As such, the communication device 246 generally comprises a modem, server, or other device for communicating with other devices on the network 201.

As further illustrated in FIG. 2, the financial institution server 208 comprises computer-readable instructions 254 stored in the memory device 250, which in one embodiment includes the computer-readable instructions 254 of a financial institution application 258. In some embodiments, the memory device 250 includes data storage 252 for storing data related to the financial institution application 258 including but not limited to data created and/or used by the financial institution application 258.

In the embodiment illustrated in FIG. 2 and described throughout much of this specification, the financial institution application 258 allows for the replacement of payment device account numbers with mobile wallet account numbers in a mobile wallet. In this way, a user 202 may not have to store any payment device account numbers on his/her mobile wallet, such that if his/her mobile wallet gets misplaced, the user 202 may not have to cancel and re-open all payment device accounts associated with the mobile wallet. As such, the financial institution application 258 may recognize mobile wallet users, provide mobile wallet account numbers, store payment device account numbers, determine which payment device the user utilized during the mobile wallet transaction using the mobile wallet account number, allow for merchants to acceptance mobile wallet account numbers for transaction, and reconciliation of mobile wallet account number transactions with payment devices.

In some embodiments the financial institution application 258 may recognize mobile wallet users 202. A mobile wallet may be any type of digital wallet that may be an alternative payment method using a mobile device to pay for a product. Mobile wallets allow a user 202 to make electronic commerce transactions via his/her mobile device quickly and securely. The financial institution application 258 may recognize mobile wallet users 202 in several ways. In some embodiments, the user 202 may provide the financial institution application 258 with information associated with a mobile wallet, including setting up the mobile wallet, adding payment devices to the mobile wallet, making a transaction with the mobile wallet and the like. This information may be provided from the user 202 by manual input and/or may be automatically provided.

Once the financial institution application 258 recognizes and determines that a user 202 is using a mobile wallet for transactions, the financial institution application 258 may determine the one or more payment devices that the user 202 has added to his/her mobile wallet. In some embodiments, the user 202 may have one payment device associated with a mobile wallet, such as a credit card or debit card. In other embodiments, the user 202 may have multiple payment devices associated with a mobile wallet. As such, financial institution application 258 may determine the one or more payment devices and the payment device account numbers associated therewith that a user 202 has associated with his/her mobile wallet. This may be done by accessing the user's mobile wallet, reviewing mobile wallet transactions, monitoring payment devices added to the mobile wallet, and/or the like.

The financial institution application 258 may then store the payment device account numbers associated with the payment devices a user 202 has on his/her mobile wallet. In this way, the financial institution application 258 may store the payment device account numbers and associate those account numbers with the mobile wallet account number once created. As such, when a mobile wallet transaction is processed by a merchant, the financial institution application 258 may recognize the mobile wallet account number associated with that transaction. In some embodiments, the financial institution application 258 may subsequently provide the merchant with the payment device account number to apply the transaction to. In other embodiments, the financial institution application 258 may subsequently apply the transaction directly to the payment device account number without merchant involvement.

The financial institution application 258 may then create, assign, and provide mobile wallet account numbers to a user 202. The financial institution application 258 may first create a mobile wallet account number for the user's mobile wallet. In some embodiments, the mobile wallet account number may be permanently associated with the mobile wallet. In some embodiments, the mobile wallet account number may be temporarily associated with the mobile wallet. In some embodiments, the mobile wallet account number may be a one-time use account number for the mobile wallet. The created mobile wallet account number may be numbers, letters, symbols, or the like that may be recognized by a merchant or POT system 206 as an account number, such that the mobile wallet account number may be used for purchasing a product. Furthermore, the created mobile wallet account number may be a distinct number that is differentiated from any traditional financial institution account number or any other account number associated with a payment device. However, the mobile wallet account number may be created by the financial institution application 258 such that it may be recognized at a POT system 206 or merchant as being associated with a payment device capable of being used for a transaction.

The financial institution application 258 may then assign a mobile wallet account number to a user's mobile wallet. The assigned mobile wallet account number may be stored in the memory device 250 in conjunction with the payment device account numbers determined to be associated with the payment devices on the user's mobile wallet. In this way, upon presentment of a mobile wallet account number the financial institution application 258 may be able to determine the payment devices associated therewith. Furthermore, the financial institution application 258 may be able to match the mobile wallet account number to payment device account numbers in order to apply the transaction using the mobile wallet to the appropriate payment device account number.

The financial institution application 258 may then provide the user 202 via the user device 204 the assigned mobile wallet account number. Once the financial institution application 258 has assigned a mobile wallet account number and has subsequently associated that mobile wallet account number with the payment device account numbers for the payment devices on the mobile wallet, the financial institution application 258 may communicate the mobile wallet account number to the user 202. This communication may be through a network 201 to the user device 204.

Next, after a user 202 completes a transaction using his/her mobile wallet, the financial institution application 258 may determine which payment device the user 202 utilized during the transaction. Because the transaction may have included the mobile wallet account number and not a payment device account number, a merchant may not know the correct payment device account to apply the transaction to. As such, the financial institution application 258 may determine which payment device the user 202 utilized during the transaction. In some embodiments, the user 202 may manually select the payment device that he/she wishes to use for the transaction. In other embodiments, the financial institution application 258 may automatically select the payment device to be used for the transaction. The automatic selection by the financial institution application 258 may be based on the user's transaction history, determined best payment device for the transaction, or the like Using transaction history to determine the payment device account to apply the transaction may include, but is not limited to selecting the payment device the user 202 typically uses for a transaction with that merchant, selecting the payment used most by the user 202 in general. In other embodiments the financial institution application 258 may determine the best payment device for the transaction and apply the transaction to the account associated with that transaction. As such, the financial institution application 258 may have a built in learning or artificial intelligence application that may learn the best offers, promotions, cash back, or the like for each payment device. As such, the financial institution application 258 may determine the best payment device to apply the transaction to, based on the type of transaction and best offers associated with the payment device if used for that transaction.

For example, if a user 202 uses his/her mobile wallet to purchase gas at a gas station. The mobile wallet will present the mobile wallet account number to purchase the gas at the gas station. As such, the gas station may receive and authorize the transaction for the purchase of gas with the mobile wallet account number. The gas station may then present the transaction to the financial institution application 258 in order to receive payment for the purchase. The financial institution application 258 may review the various payment devices and select the payment device account that gives the user 202 the most cash back for purchases at that particular gas station. As such, the financial institution application 258 may apply the transaction to that payment device account.

As such, the financial institution application 258 may allow, accept, and/or authorize a merchant to accept the mobile wallet account number for a transaction. In this way, the user 202 may not have to present the merchant with a payment device account number, such as in a typical transaction. The user 202, instead, may be able to present his/her mobile wallet with the mobile wallet account number associated therewith at a POT system 206, merchant, or the like. The merchant may then attempt to process a transaction with the mobile wallet account number. The financial institution application 258 may allow the merchant to process the transaction with the mobile wallet account number. In some embodiments, the financial institution application 258 may immediately reconcile the mobile wallet account number with a payment device account number, such that the financial institution application 258 may provide the merchant with the payment account number for processing the transaction. In other embodiments, the financial institution application 258 may allow the merchant to process the transaction using the mobile wallet account number. The financial institution application 258 may then later apply the transaction to the appropriate payment device account number.

Finally, the financial institution application 258 may allow for reconciliation of the payment amount associated with the mobile wallet account number with a payment device account number. As such, the transactions a user 202 has entered into using his/her mobile wallet and the payment amount associated with the transaction may be removed from the mobile wallet account number and applied to one or more of the account numbers associated with the payment devices. As such, the transaction may be applied to one or more of the payment devices such that the user 202 may be billed for the transaction through a statement associated with the payment device.

As illustrated in FIG. 2, the POT system 206 generally comprises a reading device 235, a presentment device 237, a communication device 236, a processing device 238, and a memory device 240. The reading device 235 is operatively coupled to the processing device 238, communication device 236, and the memory device 240. The POT system 206 may include a reader device 235 to receive payment from a user 202, such as mobile wallet account numbers presented through the mobile wallet of the user 202, financial institution server 208, payment device supplier servers 210, and/or other potential user 202 payment devices. Such a reader device 235 may include, but is not limited to a magnetic strip reader, a barcode scanner, a radio frequency (RF) reader, a character recognition device, a magnetic ink reader, an NFC reading device, a processor for interpreting codes presented over an electrical or optical medium, a biometric reader, a wireless receiving device, and/or the like. In some embodiments the reader device 235 may be able to recognize and read a user's mobile wallet. As such, the reader device 235 may receive a mobile wallet account number when the user 202 is attempting to transact with a merchant at a POT system 206. The mobile wallet account number may be used by a user 202 in place of a payment device account number at a POT system 206 to initiate a transaction. The mobile wallet account number may be processed by a POT system 206 in the same or similar way as a payment device account number would be. In this way, the user 202 may present his/her mobile wallet at a POT system 206, such that the mobile wallet account number is presented and processed by the POT system 206 instead of a typical payment device account number. The mobile wallet account number may be a distinct number that is different from any traditional financial institution account number or any other account number associated with a payment device. However, the mobile wallet account number may be utilized for a transaction for a product. The mobile wallet account number may be numbers, letters, symbols, or the like that may be recognized at a POT system 206 as an account number, such that the mobile wallet account number may be used for purchasing a product.

The mobile wallet account number may then be communicated via the communication device 236 over a network 201, to other systems such as, but not limited to the financial institution server 208 and/or the payment device supplier server 210. As such, the communication device 236 generally comprises a modem, server, or other device for communicating with other devices on the network 201.

The POT system 206 may also comprise a presentment device 237. A person of ordinary skill in the art will appreciate that the presentment device 237 may be a standalone device, may be incorporated into the POT system 206 (such as in the reader device 235), and/or the like. The presentment device 237 may include a screen presentment, reflection presentment, augmented image presentment, touchless communication, touch communication, or other medium that may be viewable and/or scannable.

As further illustrated in FIG. 2, the POT system 206 comprises computer-readable instructions 242 stored in the memory device 240, which in one embodiment includes the computer-readable instructions 242 of a merchant application 244. A POT system 206 may refer to any device that may be configured to carry out a transaction.

In some embodiments, a POT system 206 is or includes an interactive computer terminal that is configured to initiate, perform, complete, and/or facilitate one or more transactions. A POT system 206 could be or include any means that a user 202 may use to perform a transaction with an merchant, such as, but not limited to, a mobile wallet, an ATM, a loyalty device such as a rewards card, loyalty card or other loyalty device, a magnetic-based payment device (e.g., a credit card, debit card, or the like), a personal identification number (PIN) payment device, a contactless payment device (e.g., a key fob), a radio frequency identification device (RFID) and the like, a computer, (e.g., a personal computer, tablet computer, desktop computer, server, laptop, or the like), a mobile device (e.g., a smartphone, cellular phone, personal digital assistant (PDA) device, MP3 device, personal GPS device, or the like), a merchant terminal, a self-service machine (e.g., vending machine, self-checkout machine, or the like), a public and/or business kiosk (e.g., an Internet kiosk, ticketing kiosk, bill pay kiosk, or the like), a gaming device, and/or various combinations of the foregoing.

In some embodiments, a POT system 206 is operated in a public place (e.g., on a street corner, at the doorstep of a private residence, in an open market, at a public rest stop, or the like). In other embodiments, the POT system 206 is additionally or alternatively operated in a place of business (e.g., in a retail store, post office, banking center, grocery store, factory floor, or the like).

The POT system 206 as discussed herein may include any point-of-transaction device, such as a cash register, ATM, smart phone, back end server of a merchant, or the like As such, the POT system 206 may be able perform a sale, an account balance check, a reward transfer, and account money transfer, a user 202 opening up a bank application on his mobile device or computer, a user 202 using his/her e-wallet, and/or the like.

In the embodiment illustrated in FIG. 2, the merchant application 244 allows the POT system 206 to be communicably linked to the financial institution server 208 and other devices on the network 201 to communicate, via a network 201, a transaction initiation using a mobile wallet, communicate a mobile wallet account number, receive a corresponding payment device account number associated with the mobile wallet, and process a transaction.

In some embodiments, the merchant application 224 may communicate a transaction initiation, wherein the user 202 initiating the transaction is using a mobile wallet. In this way, the merchant application 224 may, in some embodiments, notify the financial institution server 208 if/when a transaction is occurring where the user 202 is using a mobile wallet. As such, the financial institution server 208 may be able to identify the payment device and associated payment device accounts associated with the mobile wallet account number. In this way, the financial institution server 208 may provide the POT system 206 with the payment device account information for processing the transaction at the POT.

In some embodiments, the merchant application 224 may receive a corresponding payment device account number associated with the mobile wallet. Once the merchant application 224 communicates the provided mobile wallet account number to the financial institution server 208, the financial institution server 208 may match the mobile wallet account number with one or more payment device account numbers that are associated with the mobile wallet. As such, the merchant application 224 may then receive a communication via the network 201 of the one or more payment device account numbers in order to process the transaction.

In some embodiments, upon receipt of the payment device account number, the merchant application 224 may process the transaction. In some embodiments, the merchant may process the transaction. In some embodiments, the financial institution may process the transaction. In yet other embodiments, the payment device supplier may process the transaction. The transaction may be processed and the payment may be posted to the appropriate payment device account statement.

FIG. 2 also illustrates a user device 204. The user device 204 generally comprises a communication device 212, a processing device 214, and a memory device 216. The processing device 214 is operatively coupled to the communication device 212 and the memory device 216. The processing device 214 uses the communication device 212 to communicate with the network 201 and other devices on the network 201, such as, but not limited to the POT system 206, payment device supplier server 210, and the financial institution server 208. As such, the communication device 212 generally comprises a modem, server, or other device for communicating with other devices on the network 201.

As further illustrated in FIG. 2, the user device 204 comprises computer-readable instructions 220 stored in the memory device 216, which in one embodiment includes the computer-readable instructions 220 of a user application 222. In this way, the user application 222 allows a user 202 to have and/or support a mobile wallet. A “user device” 204 may be any mobile communication device, such as a cellular telecommunications device (e.g., a cell phone or mobile phone), personal digital assistant (PDA), a mobile Internet accessing device, or other mobile device including, but not limited to portable digital assistants (PDAs), pagers, mobile televisions, gaming devices, laptop computers, cameras, video recorders, audio/video player, radio, GPS devices, any combination of the aforementioned, or the like. Although only a single user device 204 is depicted in FIG. 2, the system environment 200 may contain numerous user devices 204.

In some embodiments, the user application 222 allows a user 202 to utilize his/her mobile device 204 as a mobile wallet to use for purchase of a transaction at a point-of-transaction (POT). As such, the user application 222 may provide information about user 202 added payment devices to the financial institution server 208, receive the mobile wallet account number assigned to the mobile wallet, and allow the user 202 to utilize the user device 204 as a mobile wallet for transactions at a POT using the mobile wallet account number for the transaction.

The user application 222 may allow a user 202 to add payment devices to his/her mobile wallet. As such, the user application 222 may provide information associated with the added payment devices to the system, such that the system may be able to create and match a mobile wallet account number to the payment devices the user 202 has on his/her mobile device. The user device 204 may communicate the information associated with the added payment device via the communication device 212 through a network 201 to the financial institution server 208.

The user application 222 may then, upon opening a mobile wallet, adding payment devices, or upon user 202 request, receive a mobile wallet account number that may be assigned to the mobile wallet. Once the user application 222 has received the mobile wallet account number, the user application 222 may store the mobile wallet account number in the memory device 216. Furthermore, once the mobile wallet account number has been stored, the user application 222 may then provide all of the payment device account numbers associated with all of the payment devices stored on the mobile wallet to the system. In this way, the financial institution server 208 may then store the payment device account numbers received in association with the mobile wallet account number provided to the user application. As such, the financial institution server 208 may have access to each payment device account that the user 202 may have on his/her mobile wallet.

Furthermore, the user application 222 may then remove all payment device account numbers stored within the user device 204 upon receiving the mobile wallet account number. In this way, if the user device 204 gets misplaced and another individual finds the user device 204. The other individual will not have access to all of the payment device account numbers for the payment accounts the user 202 may have in his/her mobile wallet. Instead, the other individual may only have access to the mobile wallet account number. However, upon misplacing the user device 204, the user 202 may request cancellation of the mobile wallet account number. In this way, the user 202 may only have to cancel the mobile wallet account number and not each and every account number associated with each of the payment devices the user 202 has on his/her mobile wallet. As such, there is no effect on the other transactions, such as automatic transactions or the like, that may occur with respect to the payment devices.

Finally, the user application 222 may allow the user 202 to utilize the user device 204 as a mobile wallet for transactions at a POT using the mobile wallet account number for the transaction. In this way, any time the user 202 may use his/her mobile wallet to complete a transaction, the user 202 may provide his/her mobile wallet to the merchant. The user application 222 may then present to the merchant the mobile wallet account number associated with the mobile wallet. This will initiate the transaction, without the user 202 or user application 222 having to provide the payment device itself.

FIG. 2 also illustrates a payment device supplier server 210. The payment device supplier server 210 is operatively coupled to the financial institution server 208, user device 204, and/or the POT system 206 through the network 201. The payment device supplier server 210 has systems with devices the same or similar to the devices described for the financial institution server 208, user device 204, and/or the POT system 206 (i.e., communication device, processing device, and memory device). Therefore, the payment device supplier server 210 may communicate with the financial institution server 208, user device 204, and/or the POT system 206 in the same or similar way as previously described with respect to each system. The payment device supplier server 210, in some embodiments, is comprised of systems and devices that allow for receiving and sending payment device account numbers and/or mobile wallet account numbers.

It is understood that the servers, systems, and devices described herein illustrate one embodiment of the invention. It is further understood that one or more of the servers, systems, and devices can be combined in other embodiments and still function in the same or similar way as the embodiments described herein.

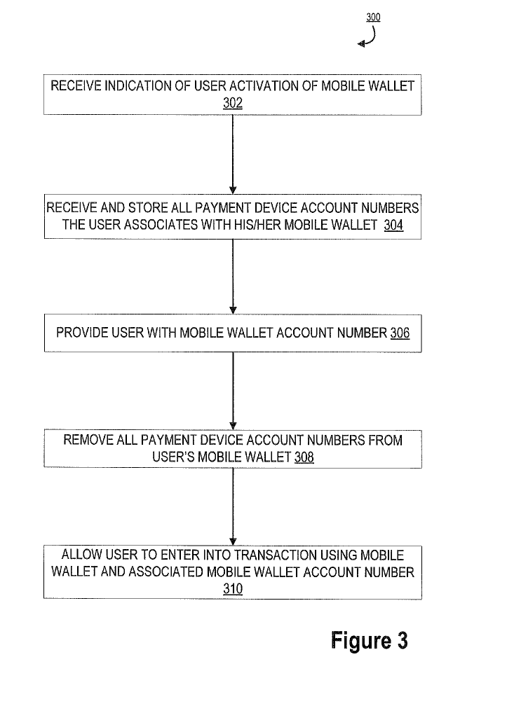

FIG. 3 illustrating a process map of initiating a mobile wallet account number differentiation system with a mobile device 300, in accordance with one embodiment of the present invention. As illustrated in block 302, the system may first receive an indication that a user 202 has activated his/her mobile wallet. The user 202 may activate a mobile wallet by initially downloading a mobile wallet for his/her user device 204. In some embodiments, the user 202 may activate a mobile wallet by selecting and opening the mobile wallet on his/her mobile wallet. In some embodiments, the user 202 may activate a mobile wallet by adding payment devices to the mobile wallet.

Next, as illustrated in block 304, once the system has determined that the user 202 uses a mobile wallet, the system may receive and store all payment device account numbers that are associated with the user's mobile wallet. The payment device accounts may include one or more of credit card numbers, debit account numbers, checking account numbers, line-of-credit account numbers, gift card numbers, and/or any other account identification information for payment devices may be received and stored in the system. In some embodiments, the user may have one payment device associated with a mobile wallet, such as a credit card or debit card. In other embodiments, the user may have multiple payment devices associated with a mobile wallet.

As illustrated in block 306, once the system has received and stored all the payment device account numbers that are associated with the user's mobile wallet, the system may provide the user 202 with a mobile wallet account number. In some embodiments, the mobile wallet account number may be permanently associated with the mobile wallet. In some embodiments, the mobile wallet account number may be temporarily associated with the mobile wallet. In some embodiments, the mobile wallet account number may be a one-time use account number for the mobile wallet. The mobile wallet account number is a distinct number that is different from any traditional financial institution account number or any other account number associated with a payment device. The mobile wallet account number may be used by the user 202 at a merchant to provide payment for a transaction. As such, the mobile wallet account number may act similarly to a payment device account number in that upon presentation of the mobile wallet account number to a merchant, the merchant may be able to initiate and process the transaction. In this way, the mobile wallet account number may be presented by a mobile wallet and be used as a traditional payment device account number to purchase a product during a transaction. In this way, a merchant may accept the mobile wallet account number as satisfying the payment for a transaction.

Once all of the payment device account numbers associated with the user's mobile wallet are stored and the user 202 has received the mobile wallet account number, the system may allow for the removal of all payment device account numbers from the user's mobile wallet, as illustrated in block 308. In some embodiments, the user 202 may manually remove the payment device account numbers associated with the payment devices on the user's mobile wallet. In some embodiments, the system may automatically remove the payment device account numbers associated with the payment devices on the user's mobile wallet. In this way, the user device 204 may not have any data stored on it that may be associated with payment devices and/or utilized by individuals other than the user 202 for transactions. As such, if the user's user device 204 gets misplaced, the user 202 may not have to cancel and/or re-open each account associated with the mobile wallet. The user 202 may simply cancel the mobile wallet account number associated with the mobile wallet and be re-issued a new mobile wallet account number. The system may then tie the new mobile wallet account number to the user's payment device accounts stored.

Finally, as illustrated in block 310, a user 202 may be allowed to enter into a transaction with a merchant using the mobile wallet and the mobile wallet account number associated therewith. As discussed above, the mobile wallet account number may be accepted at a merchant for initiation and payment for a transaction.

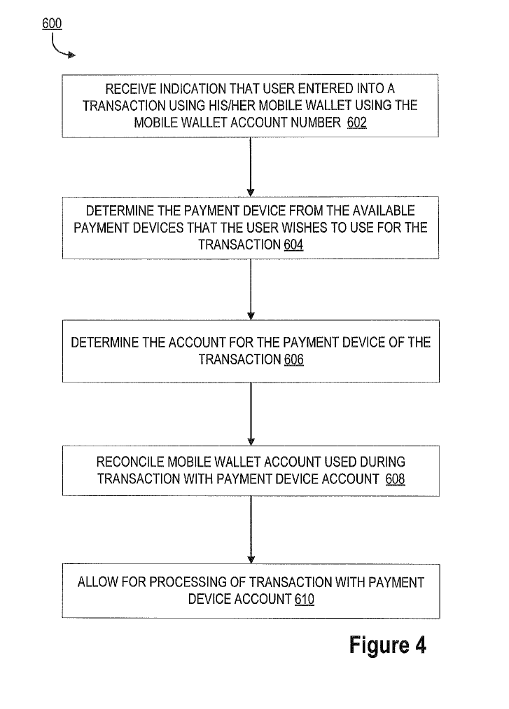

FIG. 4 illustrates a process map of the system when a user is using a mobile wallet with a mobile wallet account number differentiation system, in accordance with one embodiment of the present invention 600. As illustrated in block 602, the system may receive an indication that the user 202 entered into a transaction using his/her mobile wallet with the mobile wallet account number. This indication may be from the POT, such as the POT system 206 of a merchant.

Once the system has received an indication that the user 202 is entering into a transaction using his/her mobile wallet with a mobile wallet account number, the system may determine the payment device the user 202 wishes to use for the transaction, as illustrated in block 604. The payment device may be selected from the one or more payment devices the user 202 may have available to him/her via his/her mobile wallet. As such, the system may determine which payment device the user 202 is going to use for the transaction. In some embodiments, the user 202 may manually select the payment device that he/she wishes to use for the transaction. In other embodiments, the system may automatically select the payment device to be used for the transaction. As described above, the automatic selection by the financial system may be based on the user's transaction history, determined best payment device for the transaction, or the like

Once the payment device has been selected for the transaction using the mobile wallet and the mobile wallet account number, the system may determine the account number for the selected payment device, as illustrated in block 606. The account number may be determined by communications with the payment device supplier and/or the financial institution. At this point, the system may have the account number for the payment device that the user 202 wishes to use for the transaction where the user 202 used a mobile wallet with the mobile wallet account number at the POT.

Next, as illustrated in block 608, the system may reconcile the mobile wallet account number used during the transaction with the payment device account number determined at block 606. Now, the system may match the mobile wallet account number used during the transaction with the payment device account that the user 202 wishes to use for payment for the transaction. As such, as illustrated in block 610, the system allows for processing of the transaction using the payment device account. In this way, the user 202 may have provided a mobile wallet account number for a transaction.

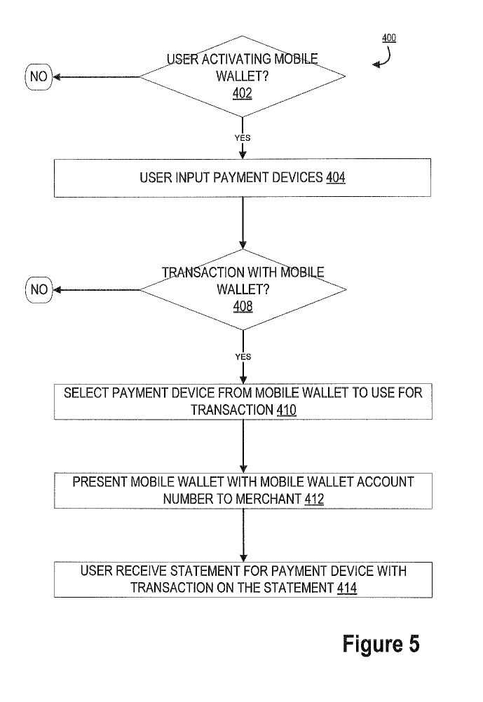

FIG. 5 illustrates a process map of a user using the mobile wallet with the mobile wallet account number differentiation system 400, in accordance with one embodiment of the present invention. As illustrated in decision block 402, the user 202 may activate his/her mobile wallet. If the user 202 does not activate his/her mobile wallet, the mobile wallet account number differentiation system may be terminated. If the user 202 does activate his/her mobile wallet at decision block 402, the user 202 may input payment devices onto his/her mobile wallet, as illustrated in block 404.

At this point, the system may replace the payment device account numbers associated with each payment device with a mobile wallet account number. As such, the payment device account numbers may be removed from the mobile wallet completely.

Once the payment device account numbers are removed completely form the mobile wallet and the mobile wallet has a universal mobile wallet account number associated with all of the payment devices within the mobile wallet, the user 202 may decide in decision block 408 to complete a transaction with the mobile wallet. If the user 202 does not decide to complete a transaction using a mobile wallet, the process may be terminated. If the user 202 decides to complete a transaction using the mobile wallet in decision block 408, the user 202 may, in some embodiments, select the payment device to use for the transaction, as illustrated in block 410. In some embodiments, the user 202 may select the payment device before the transaction. In some embodiments, the user 202 may select the payment device after the transaction. In some embodiments, the system may select the payment device automatically for the user.

Next, as illustrated in block 412, the user may present the mobile wallet that includes the mobile wallet account number (not a payment device account number) to the merchant to complete the transaction. The merchant may process the transaction using the mobile wallet account number. The system may then reconcile the merchant account number with the payment device selected for the transaction. As such, once reconciliation has occurred, the user may receive a statement for the payment device, with the transaction on the statement, as illustrated in block 414.

In this way, the user 202, user device, and/or mobile wallet may only have access to the mobile wallet account number. The mobile wallet account number may not be directly associated with any payment device. As such, the mobile wallet account number may be cancelled, changed, updated, or the like without having to change other associations or arrangements a user 202 may have with a payment device, such as direct deposit, automatic bill pay, or the like The mobile wallet account number may be secondarily associated with payment devices. As such, when the system recognized that a mobile wallet account number was used for a transaction, that transaction may be applied to a payment device account number that is associated with the mobile wallet and the mobile wallet account number.

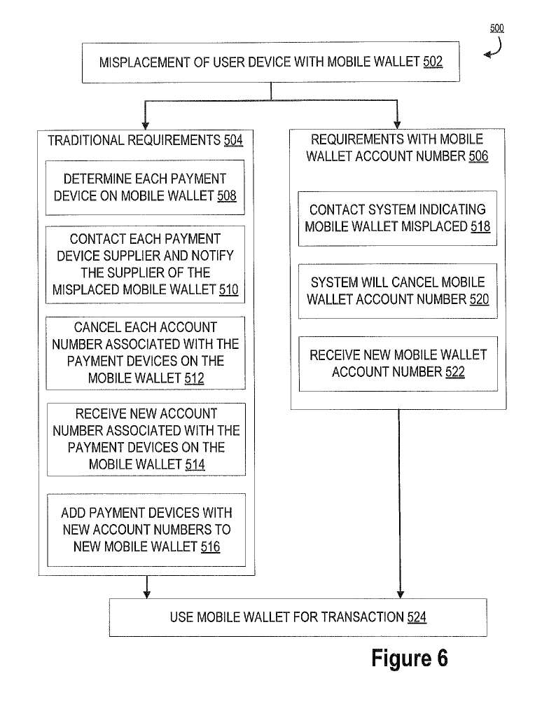

FIG. 6 illustrates a process map comparing the steps a user may have to take when a mobile wallet is misplaced 500, in accordance with one embodiment of the invention. Traditionally, a mobile wallet may include account numbers, names, expiration dates, or the like that are associated with payment devices added to the mobile wallet. For example a user 202 may input Credit Card 1 onto his/her mobile wallet. The information stored in the mobile wallet may have included only the information necessary to make a payment using Credit Card 1. As such, the account number, expiration date, security code, name, and the like may have been stored within the mobile wallet. However, if a mobile wallet of a user 202 is misplaced, as illustrated in block 502, the user 202 may have to go through great lengths to cancel the account numbers associated with each payment device associated with the mobile wallet and to receive new account numbers for those payment accounts. As such, this cancellation may affect any automatic transaction or the like associated with the payment device.

Section 504 illustrates the traditional requirements a user 202 may have to take when a mobile wallet is misplaced. First, the user 202 may have to remember and determine each payment device that he/she may have on his/her mobile wallet, as illustrated in block 508. Next, as illustrated in block 510, the user 202 may have to contact each and every payment device supplier of the misplaced mobile wallet. When contacting the payment device supplier, the user 202 may have to cancel each account number associated with the payment devices on the mobile wallet, as illustrated in block 514. Once the payment device accounts have been cancelled, the user 202 may receive new payment device account numbers associated with each payment device on the mobile wallet, as illustrated in block 514. As such, the user 202 may have to re-establish any automatic transactions associated with the payment device accounts. Finally, as illustrated in block 516 the user 202 may have to add the new payment devices with new payment device account numbers to the new mobile wallet. The user 202 may then be able to use the mobile wallet for a transaction, as illustrated in block 524.

Section 506 illustrates the requirements a user 202 may have to take when a mobile wallet is misplaced that has the mobile wallet account number differentiation program associated therewith. First, the user 202 may have to contact the system indication that his/her mobile wallet has been misplaced, as illustrated in block 518. Next, as illustrated in block 520 the system may cancel the mobile wallet account number and any subsequent transactions associated with that mobile wallet account number. Finally, the system may issue a new mobile wallet account number for the user's mobile wallet, as illustrated in block 522. The user 202 may then be able to use the mobile wallet for a transaction, as illustrated in block 524. In this way, the actual payment device account numbers are never misplaced. As such, they do not need to be cancelled and/or re-issued under new account numbers. Thus the user 202 may only have to cancel and receive a new mobile wallet account number without affecting the actual payment account or any automatic transactions associated therewith.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, or the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a verity of ways, including, for example, by having one or more general-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, or the like) that can direct a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for providing a mobile wallet account number, the system comprising:
a memory device with computer-readable program code stored thereon;
a communication device;
a processing device operatively coupled to the memory device and the communication device, wherein the processing device is configured to execute the computer-readable program code to:
receive an indication that a user has activated a mobile wallet, wherein the mobile wallet comprises one or more payment devices;
receive data associated with each of the one or more payment devices associated with the mobile wallet, wherein the data includes the payment devices account number;
create a mobile wallet account number for the one or more payment devices;
store the mobile wallet account number in association with the payment device account number for each of the one or more payment devices;
receive an indication that the user is entering into a transaction using the mobile wallet, wherein the transaction comprises presenting the mobile wallet and mobile wallet account number to a merchant;
determine the one or more payment devices associated with the mobile wallet account number; and
apply the transaction to an appropriate payment device account.

2. The system of claim 1, wherein the processing device is further configured to execute the computer-readable program code to:
determine the appropriate payment device account associated with the one or more payment devices associated with the mobile wallet account number, wherein determining the appropriate payment device account associated with the one or more payment devices comprises at least one of:
determining a payment device from the one or more payment devices the user has used in previous transactions with the merchant;
determining a payment device from the one or more payment devices that provides the user with incentives when transaction with the merchant; or
receiving a manual input from the user indication the appropriate payment device; and
apply the transaction to the determined appropriate payment device account.

3. The system of claim 1, wherein creating the mobile wallet account number for all of the one or more payment devices further comprises allowing the user to remove the payment device account numbers from the mobile wallet and replace the payment device account numbers with the single mobile wallet account number.

4. The system of claim 1, wherein applying the transaction to an appropriate payment device account further comprises:
matching the mobile wallet account number with the payment device account numbers associated with the mobile wallet;
determining the appropriate payment device account from the payment device account numbers associated with the mobile wallet account number;
accessing the appropriate payment device account number; and
allowing for transaction processing of the appropriate payment device account number.

5. The system of claim 1, wherein the mobile wallet account number is an acceptable form of payment for a transaction at a merchant, wherein the mobile wallet account number is not directly associated with a payment device account number.

6. The system of claim 1, wherein the mobile wallet account number is associated with the mobile wallet until the user cancels the mobile wallet account number.

7. The system of claim 1, wherein the mobile wallet account number is a one-time use account number, such that after each transaction the mobile wallet account number changes.

8. The system of claim 1, wherein the processing device is further configured to execute the computer-readable program code to:
receive an indication of a misplaced mobile wallet;
receive a request to cancel and re-issue a mobile wallet account number; and
provide the user with a new mobile wallet account number based on the request, wherein the one or more payment devices associated with the misplaced mobile wallet remain unaffected by the misplacement of the mobile wallet, such that the payment device account numbers associated with the one or more payment devices do not require cancelling.

9. A computer program product for providing a mobile wallet account number, the computer program product comprising at least one non-transitory computer-readable medium having computer-readable program code portions embodied therein, the computer-readable program code portions comprising:
an executable portion configured for receiving an indication that a user has activated a mobile wallet, wherein the mobile wallet comprises one or more payment devices;
an executable portion configured for receiving data associated with each of the one or more payment devices associated with the mobile wallet, wherein the data includes the payment devices account number;
an executable portion configured for creating a mobile wallet account number for the one or more payment devices;
an executable portion configured for storing the mobile wallet account number in association with the payment device account number for each of the one or more payment devices;
an executable portion configured for receiving an indication that the user is entering into a transaction using the mobile wallet, wherein the transaction comprises presenting the mobile wallet and mobile wallet account number to a merchant;
an executable portion configured for determining the one or more payment devices associated with the mobile wallet account number; and
an executable portion configured for applying the transaction to an appropriate payment device account.

10. The computer program product of claim 9 further comprising:
an executable portion configured for determining the appropriate payment device account associated with the one or more payment devices associated with the mobile wallet account number, wherein determining the appropriate payment device account associated with the one or more payment devices comprises at least one of:
determining a payment device from the one or more payment devices the user has used in previous transactions with the merchant;
determining a payment device from the one or more payment devices that provides the user with incentives when transaction with the merchant; or
receiving a manual input from the user indication the appropriate payment device; and
an executable portion configured for applying the transaction to the determined appropriate payment device account.

11. The computer program product of claim 9, wherein creating the mobile wallet account number for all of the one or more payment devices further comprises allowing the user to remove the payment device account numbers from the mobile wallet and replace the payment device account numbers with the single mobile wallet account number.

12. The computer program product of claim 9, wherein applying the transaction to an appropriate payment device account further comprises:
matching the mobile wallet account number with the payment device account numbers associated with the mobile wallet;
determining the appropriate payment device account from the payment device account numbers associated with the mobile wallet account number;
accessing the appropriate payment device account number; and
allowing for transaction processing of the appropriate payment device account number.

13. The computer program product of claim 9, wherein the mobile wallet account number is an acceptable form of payment for a transaction at a merchant, wherein the mobile wallet account number is not directly associated with a payment device account number.

14. The computer program product of claim 9, wherein the mobile wallet account number is associated with the mobile wallet until the user cancels the mobile wallet account number.

15. The computer program product of claim 9, wherein the mobile wallet account number is a one-time use account number, such that after each transaction the mobile wallet account number changes.

16. The computer program product of claim 9 further comprising:
an executable portion configured for receiving an indication of a misplaced mobile wallet;
an executable portion configured for receiving a request to cancel and re-issue a mobile wallet account number; and
an executable portion configured for providing the user with a new mobile wallet account number based on the request, wherein the one or more payment devices associated with the misplaced mobile wallet remain unaffected by the misplacement of the mobile wallet, such that the payment device account numbers associated with the one or more payment devices do not require cancelling.

17. A computer-implemented method for providing a mobile wallet account number, the method comprising:
providing a computing system comprising a computer processing device and a non-transitory computer readable medium, where the computer readable medium comprises configured computer program instruction code, such that when said instruction code is operated by said computer processing device, said computer processing device performs the following operations:
receiving an indication that a user has activated a mobile wallet, wherein the mobile wallet comprises one or more payment devices;
receiving data associated with each of the one or more payment devices associated with the mobile wallet, wherein the data includes the payment devices account number;
creating, via a processing device, a mobile wallet account number for the one or more payment devices;
storing the mobile wallet account number in association with the payment device account number for each of the one or more payment devices;
receiving an indication that the user is entering into a transaction using the mobile wallet, wherein the transaction comprises presenting the mobile wallet and mobile wallet account number to a merchant;
determining the one or more payment devices associated with the mobile wallet account number; and
applying the transaction to an appropriate payment device account.

18. The method of claim 17 further comprising:
determining the appropriate payment device account associated with the one or more payment devices associated with the mobile wallet account number, wherein determining the appropriate payment device account associated with the one or more payment devices comprises at least one of:
determining a payment device from the one or more payment devices the user has used in previous transactions with the merchant;
determining a payment device from the one or more payment devices that provides the user with incentives when transaction with the merchant; or
receiving a manual input from the user indication the appropriate payment device; and
applying the transaction to the determined appropriate payment device account.

19. The method of claim 17, wherein creating the mobile wallet account number for all of the one or more payment devices further comprises allowing the user to remove the payment device account numbers from the mobile wallet and replace the payment device account numbers with the single mobile wallet account number.

20. The method of claim 17, wherein applying the transaction to an appropriate payment device account further comprises:
matching the mobile wallet account number with the payment device account numbers associated with the mobile wallet;
determining the appropriate payment device account from the payment device account numbers associated with the mobile wallet account number;
accessing the appropriate payment device account number; and
allowing for transaction processing of the appropriate payment device account number.

21. The method of claim 17, wherein the mobile wallet account number is an acceptable form of payment for a transaction at a merchant, wherein the mobile wallet account number is not directly associated with a payment device account number.

22. The method of claim 17, wherein the mobile wallet account number is associated with the mobile wallet until the user cancels the mobile wallet account number.

23. The method of claim 17, wherein the mobile wallet account number is a one-time use account number, such that after each transaction the mobile wallet account number changes.

24. The method of claim 17 further comprising:
receiving an indication of a misplaced mobile wallet;
receiving a request to cancel and re-issue a mobile wallet account number; and
providing the user with a new mobile wallet account number based on the request, wherein the one or more payment devices associated with the misplaced mobile wallet remain unaffected by the misplacement of the mobile wallet, such that the payment device account numbers associated with the one or more payment devices do not require cancelling.
